(19) United States
(12) Patent Application Publication
(10) Pub. No.: US 2026/0051052 A1
(43) Pub. Date: Feb. 19, 2026

(54) IMAGE PROCESSING APPARATUS, IMAGE PROCESSING SYSTEM, AND IMAGE PROCESSING METHOD

(71) Applicant: KONICA MINOLTA, INC., Tokyo (JP)

(72) Inventor: Nodoka MACHIDA, Tokyo (JP)

(73) Assignee: KONICA MINOLTA, INC., Tokyo (JP)

(21) Appl. No.: 19/286,435

(22) Filed: Jul. 31, 2025

(30) Foreign Application Priority Data
Aug. 13, 2024 (JP) 2024-134801

(51) Int. Cl. G06T 7/00

(52) U.S. Cl. CPC G06T 7/0012; G06T 2207/10116; G06T 2207/20092; G06T 2207/30061; G06T 2207/30096

(57) ABSTRACT

Disclosed is an image processing apparatus including a hardware processor that: performs first analysis of analyzing a medical image to detect a lesion candidate area; selects the lesion candidate area in the medical image; and outputs analysis information including a determination basis of analysis by the first analysis for the selected lesion candidate area.

### CROSS-REFERENCE TO RELATED APPLICATION

The entire disclosure of Japanese Patent Application No. 2024-134801, filed on Aug. 13, 2024, including description, claims, drawings and abstract is incorporated herein by reference.

### BACKGROUND OF THE INVENTION

### Technical Field

The present invention relates to an image processing apparatus, an image processing system, and an image processing method.

### Description of Related Art

In recent years, most of artificial intelligence (AI) processing in an AI system using deep learning has processing content of a “black box”. That is, such AI processing has a complicated relation between input and output. Therefore, it is difficult for the user to understand the processing content of such AI processing.

On the other hand, there is also explainable AI (Explainable AI; XAI). Explainable AI is a technology or a method that can clearly explain how artificial intelligence (AI) derives a result or an inference. According to this, it is said that it is possible to enhance the transparency of the AI system and make it easier for the user to understand his/her decision-making process.

In addition, Japanese Unexamined Patent Publication No. 2022-146822 describes that a diagnostic result which is a character string is estimated and output from a medical image using a machine learning model, and an area on the medical image serving as a basis of a diagnostic result selected by a user among the output diagnostic results is indicated.

### SUMMARY OF THE INVENTION

However, Japanese Unexamined Patent Publication No. 2022-146822 shows, on a medical image, a basis corresponding to a diagnostic result which is a character string. Therefore, when a user such as a radiologist selects an area to be confirmed on a medical image and wants to know the analysis result of AI for the area, Japanese Unexamined Patent Publication No. 2022-146822 is not applicable.

Usually, a radiologist is a routine to make a diagnosis by viewing a medical image, and therefore, the technique described in Japanese Unexamined Patent Publication No. 2022-146822 is not user-friendly.

Therefore, an object of the present invention is to provide an image processing apparatus, an image processing system, an image processing method, and a recording medium that improve user convenience when making a diagnosis using an analysis result of a medical image.

In order to solve the above problem, an image processing apparatus according to an aspect of the present invention includes a hardware processor that:
performs first analysis of analyzing a medical image to detect a lesion candidate area;
selects the lesion candidate area in the medical image; and
outputs analysis information including a determination basis of analysis by the first analysis for the selected lesion candidate area.

In addition, the image processing system according to an aspect of the present invention includes a hardware processor that:
performs first analysis of analyzing a medical image to detect a lesion candidate area;
selects the lesion candidate area in the medical image; and
outputs analysis information including a determination basis of analysis by the first analysis for the selected lesion candidate area.

Furthermore, the image processing method according to an aspect of the present invention includes:
first analyzing that is analyzing, by an image processing apparatus, a medical image to detect a lesion candidate area;
selecting that is selecting, by the image processing apparatus, the lesion candidate area in the medical image; and
outputting that is outputting, by the image processing apparatus, analysis information including a determination basis of analysis by the first analyzing for the selected lesion candidate area.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present disclosure, and wherein:

FIG. 1 is a diagram illustrating an overall configuration of an image processing system in an embodiment of the present invention;

FIG. 2 is a block diagram illustrating the configuration of a diagnostic console (image processing apparatus);

FIG. 3 is a flowchart illustrating the lesion candidate display processing;

FIG. 4 is a diagram illustrating an example of a lesion candidate display screen;

FIG. 5 is a diagram illustrating an example of a lesion candidate display screen;

FIG. 6 is a flowchart illustrating lesion candidate display processing;

FIG. 7 is a flowchart illustrating the lesion candidate display processing;

FIG. 8 is a diagram illustrating an example of a lesion candidate display screen;

FIG. 9 is a diagram illustrating an example of a lesion candidate display screen;

FIG. 10 is a view illustrating an example of the lesion candidate display screen; and

FIG. 11 is a view illustrating an example of a lesion candidate display screen.

### DETAILED DESCRIPTION

In the following, embodiment of the present invention will be described with reference to the drawings. However, the scope of the invention is not limited to the illustrated examples.

### Configuration of Image Processing System 100

First, a configuration of the present embodiment will be described.

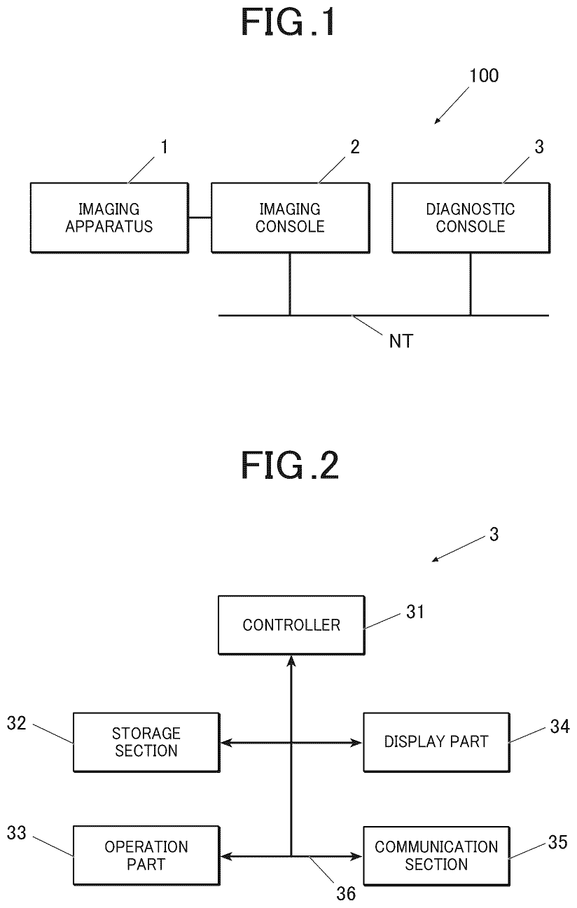

FIG. 1 illustrates an overall configuration of an image processing system 100 (image processing system) in the present embodiment.

As shown in FIG. 1, the image processing system 100 is configured such that an imaging apparatus 1 and an imaging console 2 are connected by a communication cable or the like, and the imaging console 2 and a diagnostic console 3 (image processing apparatus) are connected via a communication network NT such as a LAN (Local Area Network).

The apparatuses included in the image processing system 100 comply with the Digital Image and Communications in Medicine (DICOM) standard, and the communication between the apparatuses is performed in accordance with DICOM.

The imaging apparatus 1 is an apparatus that images a subject and generates various medical images.

The various medical images are various medical images such as a radiographic image obtained by irradiating a subject with radiation such as X-rays, an ultrasound image obtained by applying ultrasound to a subject, and mammography images of MLO (Medio-Lateral Oblique) and CC (Cranio-Caudal) obtained by mammography.

The imaging console 2 is a apparatus that outputs imaging condition to the imaging apparatus 1, controls the operation of the imaging apparatus 1, and displays various medical images acquired by the imaging apparatus 1 for confirmation of positioning and confirmation of whether or not the images are suitable for diagnosis by an imaging practitioner such as an imaging technician.

The diagnostic console 3 is an image processing apparatus that acquires various medical images from the imaging console 2 and performs various kinds of image processing (such as lesion candidate display processing to be described later) on the acquired various medical images.

The lesion candidate display processing is processing for displaying a lesion candidate area in a medical image and displaying analysis information of the selected lesion candidate area.

### Configuration of Diagnostic Console 3

As shown in FIG. 2, the diagnostic console 3 is configured to include the controller 31 (hardware processor), a storage section 32, an operation part 33, a display part 34, and a communication section 35, and the respective sections are connected by a bus 36.

The controller 31 includes a central processing unit (CPU), a random access memory (RAM), and the like. The CPU of the controller 31 reads a system program and various processing programs stored in the storage section 32 in response to an operation of the operation part 33, develops the programs in the RAM, executes various processes in accordance with the developed programs, and centrally controls the operation of each section of the diagnostic console 3.

The controller 31 functions as a first analysis section that analyzes the medical image and detects a lesion candidate area. The analysis is analysis using an analysis model such as a machine learning model.

When a medical image is input as input information, the analysis model outputs a lesion candidate area and analysis information as output information.

The lesion candidate area is a area occupied by a lesion candidate in the medical image.

The analysis information is various kinds of information obtained by analyzing a medical image, and outputs a lesion candidate name, a certainty factor, a determination basis of analysis, and the like.

The lesion candidate name is the name of a lesion candidate. The lesion candidate name may be a type of lesion.

The certainty factor is a degree indicating the possibility that a lesion candidate is the lesion. Note that when the certainty factor is equal to or more than a threshold value, the certainty factor may be expressed as positive.

The determination basis of analysis is information indicating the basis for determination of a lesion candidate in a medical image.

The controller 31 functions as a selection section that selects a lesion candidate area in a medical image.

Specifically, the controller 31 may select a lesion candidate area on the basis of an instruction input by the user with respect to the medical image, using an operation part 33 described later. In addition, the controller 31 may automatically select a lesion candidate area on the basis of an output condition to be described later.

The controller 31 functions as an output section that outputs analysis information including the determination basis of the analysis by the first analysis section for the selected lesion candidate area. Specifically, the controller 31 outputs analysis information to the display part 34.

The controller 31 may output the analysis information on the basis of output conditions described later.

The controller 31 may determine the method of outputting analysis information on the basis of the display conditions.

Examples of the display condition include a graph such as a radar chart, segmentation, an arrow, and the number of grounds. The display condition may be, for example, a condition that analysis information is output for a predetermined area in a medical image.

The controller 31 functions as a setting section that sets output conditions.

The output condition is a condition indicating whether to output the analysis information.

For example, the output condition may be a condition using analysis information. Specifically, the output condition may be a condition that the analysis information is output when the certainty factor output from the analysis model is equal to or less than a threshold value, equal to or more than a threshold value, or within a range.

Further, for example, the output condition may be a condition using a diagnostic result of a radiologist. Specifically, the output condition may be a condition that the analysis information is output when the diagnostic result of the radiologist for the lesion candidate area is negative and the output information of the analysis model is positive. Further, for example, the output condition may be a condition using a combination of the diagnostic result of the first radiologist and the diagnostic result of the second radiologist. Specifically, the output condition may be a condition that analysis information is output in a case where diagnostic results of a plurality of radiologists for a lesion candidate area do not match. Note that in the case of these conditions, it is necessary as a premise that lesion candidate display processing has been performed in advance, a certain lesion candidate area has been diagnosed by the radiologist, and the lesion candidate area and the diagnostic result have been stored in the storage section 32 in association with the medical image.

Furthermore, for example, the output condition may be that analysis information is output if at least one of the following types of information is predetermined information: the type of site of the subject associated with the medical image and stored in the storage section 32, a candidate name of lesion (the type of lesion) output from the analysis model, and the type of modality associated with the medical image and stored in the storage section 32.

Furthermore, for example, the output condition may be a condition using a combination of a past analysis result and a current analysis result that are obtained by analysis. Specifically, the output condition may be a condition that the analysis information is output in a case where the output information of the analysis model stored in the storage section 32 in association with the past medical image obtained by capturing the same portion of the same subject is different from the output information output from the analysis model by analyzing the current medical image.

In addition, for example, the output condition may be a condition that the analysis information is output when the output information output from the analysis model is associated with the patient information. The patient information includes, for example, a medical history and genetic elements of the patient. Specifically, for example, when the output information outputted from the analysis model is “nodule, infiltration” and the patient information is “cancer”, the analysis information is outputted, whereas when the patient information is “nephritis”, the analysis information is not outputted.

For example, the output condition may be that whether to output analysis information is determined on the basis of the position of a lesion candidate area output from the analysis model. For example, when nodule detection is performed on a chest X-ray image by computer-aided design (CAD), the output condition may be determined based on whether the position of a lesion candidate area is close to a blood vessel.

The controller 31 functions as a determination section to determine whether to automatically select a lesion candidate area on the basis of the image interpretation time of the medical image by the user.

The determination based on the image interpretation time of the medical image of the user is, for example, to determine whether or not the image interpretation time of the medical image of the radiologist is equal to or longer than a set time set in advance. The image interpretation time may be a time from when the output information of the analysis model is displayed on the display part 34 or a time from when a predetermined operation indicating the start of image interpretation, such as opening a predetermined image interpretation screen, is detected.

The controller 31 functions as a second analysis section that analyzes the user's previous selections for medical images to determine output conditions.

The analysis is analysis using an analysis model such as a machine learning model.

The analysis model outputs an output condition as output information when input information using the operation part 33 of the user with respect to the medical image is input as input information.

For example, in a case where it is analyzed that a user tends to select a lesion candidate area of the right lung displayed in a medical image obtained by imaging the lungs, an output condition that analysis information is always output for the lesion candidate area of the right lung is output from the analysis model.

The storage section 32 includes a nonvolatile semiconductor memory, a hard disk and the like. The storage section 32 stores various programs including a program for executing various processes in the controller 31, parameters necessary for executing the processes by the programs, or data such as processing results. These various programs are stored in the form of readable program codes, and the controller 31 sequentially executes operations in accordance with the program codes.

Specifically, the storage section 32 stores the above-described display conditions and output conditions.

In addition, the storage section 32 stores various medical images acquired from the imaging console 2, diagnostic results of a radiologist for the various medical images, and related information regarding the various medical images (a type of a site of a subject, a type of a lesion obtained from an analysis result obtained by analysis, a type of a modality of the imaging apparatus 1, and the like). In a case where there are a plurality of radiologists for various medical images, the diagnostic results are the diagnostic result of the first radiologist, the diagnostic result of the second radiologist, and so on.

The operation part 33 includes a keyboard including cursor keys, number input keys, and various function keys, and a pointing device such as a mouse, and outputs, to the controller 31, an instruction signal input by a user's key operation on the keyboard or mouse operation. Furthermore, the operation part 33 may include a touch screen on the display screen of the display part 34, and in this case, outputs an instruction signal input via the touch screen to the controller 31.

The display part 34 is configured by a monitor such as a liquid crystal display (LCD) or a cathode ray tube (CRT), and performs various displays in accordance with an instruction of a display signal input from the controller 31.

The communication section 35 includes a LAN adapter, a modem, a terminal adapter (TA), and the like, and controls data transmission and reception with each apparatus connected to the communication network NT.

### Operation of Diagnostic Console 3; Case 1

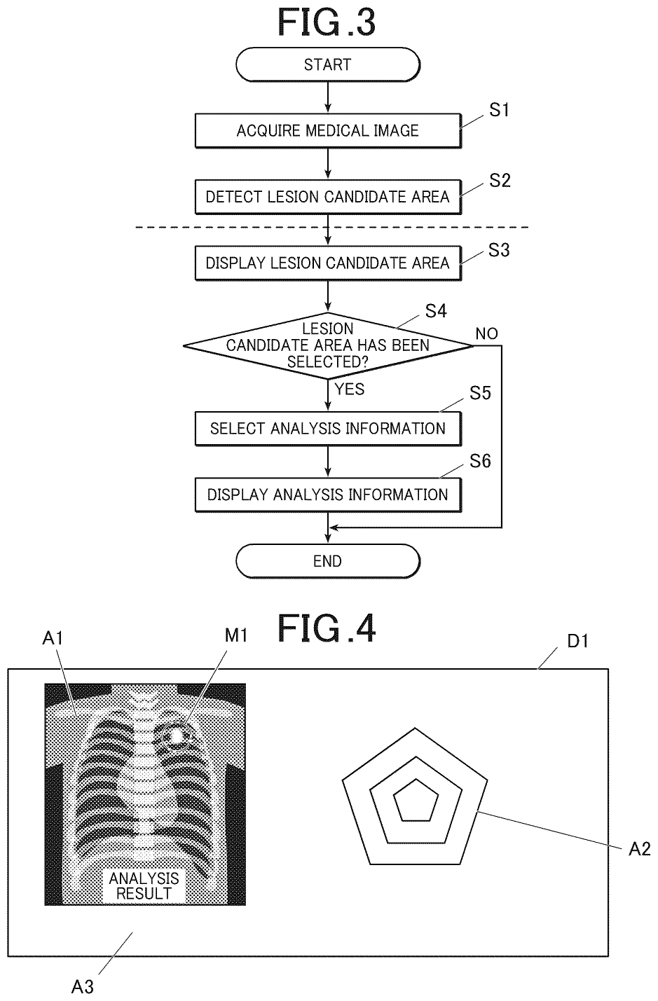

Next, lesion candidate display processing in the diagnostic console 3 will be described with reference to FIG. 3.

Note that the display conditions and the output conditions are set in advance.

First, the controller 31 acquires a medical image from the imaging console 2 (step S1).

Next, the controller 31 analyzes the medical image using the analysis model. Next, the controller 31 detects a lesion candidate area (step S2; first analysis step).

Steps step S1 and step S2 described above may be performed as soon as the controller 31 acquires a medical image from the imaging console 2. Next, as soon as the controller 31 acquires, from the user, a display instruction to display a lesion candidate display screen, which will be described later, using the operation part 33, the subsequent step S3 may be performed. Note that the example of the display instruction is not limited to this example, and other examples will be described later.

Next, the controller 31 causes the display part 34 to display a lesion candidate display screen D1 shown in FIG. 4 (step S3). Here, it is assumed that the display condition is a condition of display on a radar chart.

Here, the lesion candidate display screen D1 shown in FIG. 4 will be described.

The area A1 is an area where a medical image and a lesion candidate area are displayed.

The mark M1 is a mark indicating a lesion candidate area.

The area A2 is an area in which analysis information is displayed. Since the display condition is display on a radar chart, the analysis information is displayed using a radar chart.

The area A3 is an area in which a certainty factor is displayed.

Next, the controller 31 determines whether a lesion candidate area has been selected by the user using the operation part 33 (step S4; selection step). When there is a lesion candidate (step S4; YES), the controller 31 advances the lesion candidate display process to step S5. When there is no lesion candidate (step S4; NO), the controller 31 ends the lesion candidate display process.

Next, the controller 31 selects analysis information (step S5).

The controller 31 selects analysis information corresponding to the selected lesion candidate area from the analysis information output from the analysis model in step S2.

At the time of selection of analysis information, the controller 31 may select and output all of the selected analysis information, but the controller 31 may use the above-described output conditions to limit and output the analysis information to be output.

Thus, the user checks information narrowed down by the output conditions, thus preventing the check from becoming complicated.

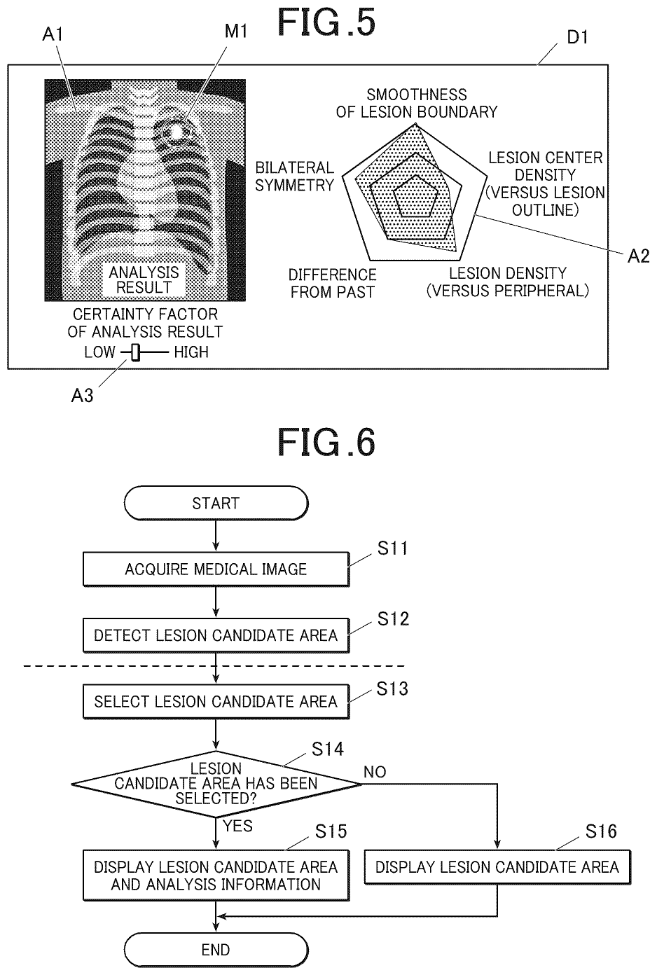

Next, as illustrated in FIG. 5, the controller 31 allows the display part 34 to display the analysis information (step S6; outputting step). Then, the controller 31 ends the lesion candidate display process.

Here, the lesion candidate display screen D1 shown in FIG. 5 will be described.

In the area A2, the smoothness of the lesion boundary, the lesion center density, the lesion density, the difference from the past, and the bilateral symmetry are displayed as analysis information in a radar chart. In this example, the inner side of the radar chart has a smaller value and is normal. Note that the difference from the past is a difference in output information (e.g., certainty factor) at the same place in the same subject.

In the area A3, a certainty factor is displayed. The certainty factor is variable by the user using the operation part 33. In a case where the outputting condition is that the certainty factor is equal to or less than a threshold value, equal to or more than a threshold value, or within a range, the user can change the display of the mark M1 displayed in the area A1 by changing the certainty factor. In this case, the controller 31 advances the lesion candidate display process to step S3. For example, the description will be given using a case where the output condition is to determine whether the position of a lesion candidate area is close to a blood vessel when nodule detection is performed by computer-aided design (CAD) on a chest X-ray image. In the initial display, all the pieces of analysis information are not displayed, and in a case where the level of the certainty factor is lowered, analysis information is additionally displayed only for a lesion candidate area to which a blood vessel is close, and in a case where the level of the certainty factor is further lowered, analysis information is displayed for all the lesion candidate areas.

### Operation of Diagnostic Console 3; Case 2

Next, lesion candidate display processing in the diagnostic console 3 will be described with reference to FIG. 6.

Note that the display conditions and the output conditions are set in advance.

Step S11 and Step S12 are the same as Step S1 and Step S2 in FIG. 3.

Next, based on the outputting conditions, the controller 31 automatically selects a lesion candidate area that satisfies the outputting conditions (step S13; selection step).

At the time of selection of a lesion candidate area, the controller 31 may select and output all of the lesion candidate areas, or the controller 31 may use the above-described output conditions to limit the selection of lesion candidate areas for output.

Thus, the user checks information narrowed down by the output conditions, thus preventing the check from becoming complicated.

Next, the controller 31 determines whether a lesion candidate area has been selected (step S14). When there is a lesion candidate (step S14; YES), the controller 31 advances the lesion candidate display process to step S15. When there is no lesion candidate (step S14; NO), the controller 31 advances the lesion candidate display process to step S16.

Next, as illustrated in FIG. 5, the controller 31 allows the display part 34 to display the lesion candidate areas and the analysis information (step S15; outputting step). Then, the controller 31 ends the lesion candidate display process.

Next, as illustrated in FIG. 4, the controller 31 allows the display part 34 to display a lesion candidate area (step S16). Then, the controller 31 ends the lesion candidate display process.

### Operation of Diagnostic Console 3; Case 3

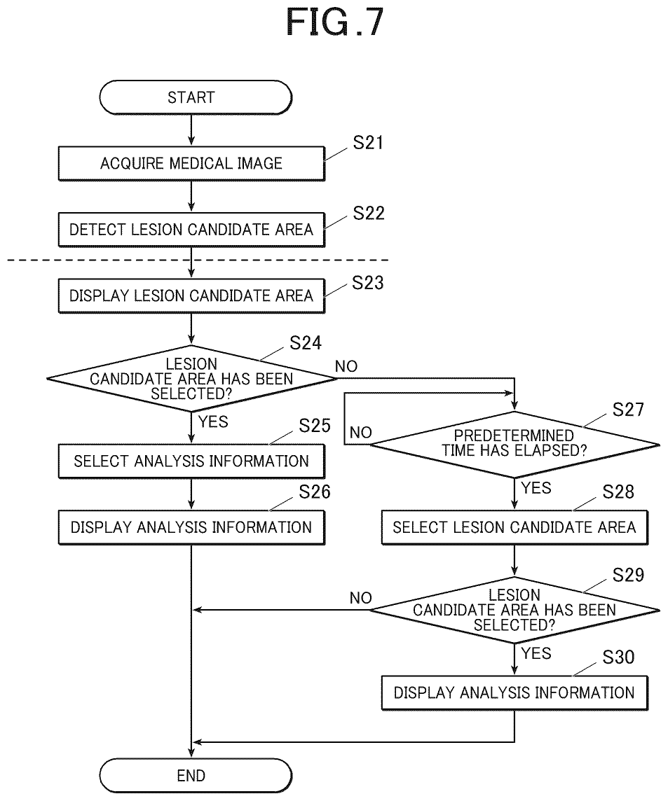

Next, lesion candidate display processing in the diagnostic console 3 will be described with reference to FIG. 7.

The lesion candidate display processing illustrated in FIG. 7 is a combination of Case 1 and Case 2 described above. Step S21 to S26 are the same as step S1 to S6 of FIG. 3. Step S28 is the same as S13 in FIG. 6.

Next, the controller 31 determines, based on the image interpretation time of the medical image by the user, whether to automatically select a lesion candidate area (step S27). In a case where it is determined that the medical image interpretation time of the user has passed the predetermined time (step S27; YES), the controller 31 advances the lesion candidate display process to step S28. In a case where it is determined that the image interpretation time of the medical image of the user does not elapse the predetermined time (step S27; NO), the controller 31 advances the lesion candidate display process to step S27.

Next, the controller 31 determines whether a lesion candidate area has been selected (step S29). When there is a lesion candidate (step S29; YES), the controller 31 advances the lesion candidate display process to step S30. When there is no lesion candidate (step S29; NO), the controller 31 ends the lesion candidate display process.

Next, as illustrated in FIG. 5, the controller 31 allows the display part 34 to display the analysis information (step S30; outputting step). Note that since the lesion candidate area is already displayed in step S23 as illustrated in FIG. 4, analysis information is additionally displayed in step S30. Then, the controller 31 ends the lesion candidate display process.

### Others

In the above description, as shown in FIGS. 4 and 5, the controller 31 displays the analysis information in the area A2 using the radar chart, but the present invention is not limited to this example.

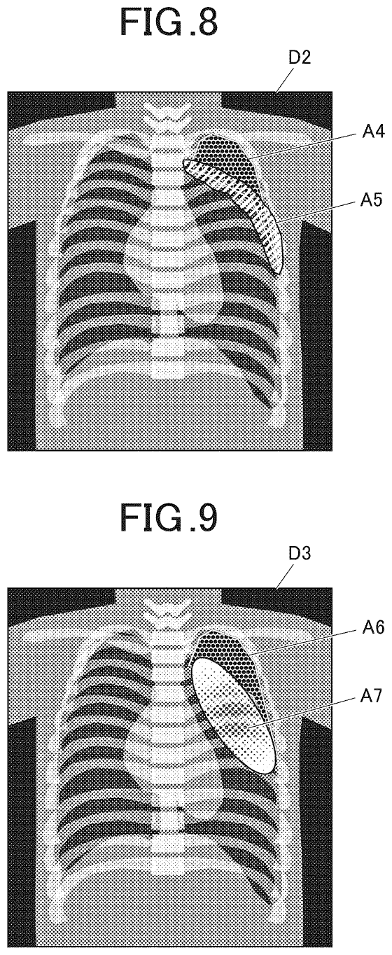

For example, as in the lesion candidate display screen D2 shown in FIG. 8 and the lesion candidate display screen D3 shown in FIG. 9, the controller 31 may display the analysis information corresponding to the lesion candidate areas A4 and A6 using the segmentations A5 and A7. The lesion candidate area A4, A6 is an example of pneumothorax. As in segmentation A7, the certainty factor may also be displayed in a heat map, and as in segmentation A5, display may be limited to a portion with a high certainty factor (a line segment feature in the lung field unique to pneumothorax). This is an image in which the position and the certainty factor of the portion serving as the determination basis are displayed together in the segmentation display.

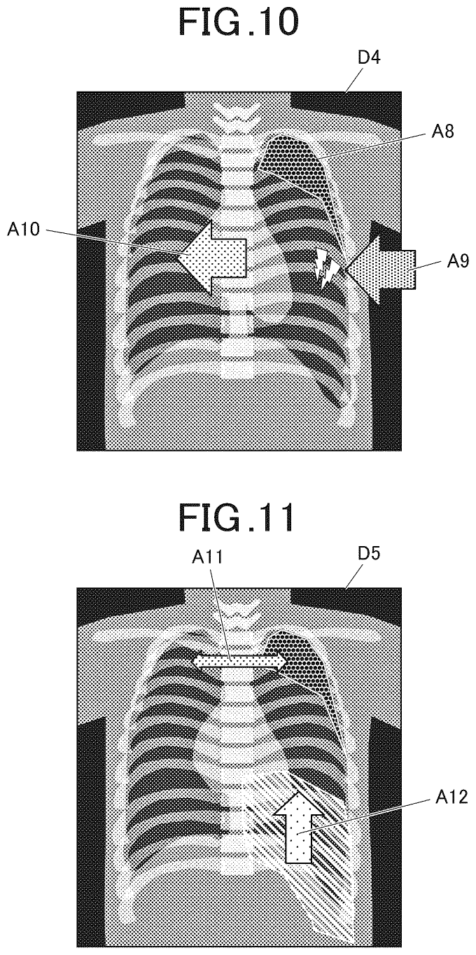

Further, for example, as in the lesion candidate display screen D4 shown in FIG. 10 and the lesion candidate display screen D5 shown in FIG. 11, the controller 31 may display the analysis information corresponding to the lesion candidate area A8 using arrows A9, A10, A11, and A12. Arrow A9 indicates a finding of a bone fracture, and arrow A10 points to the lung field. The arrow A11 indicates that there is a left/right difference in lung field features, and the arrow A12 indicates that there is a moderate diaphragmatic eventration. Note that the thickness or color of the arrow may indicate the certainty factor or the amount of change from the past. In addition, whether the target is an organ or a bone, a change state (left-right difference, elevation, or the like), or the like may be displayed so as to be identifiable by the color of the arrow. In addition, an arrow indicating pneumothorax itself and an arrow indicating the determination basis may coexist. The point to be examined can be clarified by directly designating the position serving as the determination basis with the display using the arrow.

Furthermore, the controller 31 may cause the number of reasons to be displayed. The number of grounds (bases) is the number of determination bases, and in particular, is the number of determination bases in a case where there are a plurality of determination bases for determining that the selected lesion candidate area is a lesion candidate. For example, in the example of FIG. 11, the number of grounds is two (there is a left-right difference in intra-lung field features, and there is a medium degree of diaphragmatic eventration). Thus, the user can be made aware of the existence of the information indicating the determination basis. For example, in the case of the screen display as in FIG. 8, the place of the basis may be indicated in the area A5, and the fact that there is information on an additional basis that is not displayed may be displayed with a mark, a comment, or the like together with the number of bases. Then, additional basis information may be displayed by the mark, the comment, or the like being pressed. Thus, although it is sufficient for an experienced clinician to know the location of the portion serving as the basis, a young clinician can confirm additional basis.

In the above description, when a medical image is input as input information, the analysis model outputs a lesion candidate area and analysis information as output information, but similar images may be extracted from the medical images stored in the storage section 32 and output as output information.

The lesion candidate display screen D1 may be provided with a button that allows the user to input an evaluation of the lesion candidate area or the display content of the analysis information. In this way, the evaluation information can be used to improve the analysis model.

In a case where the user checks medical images of a plurality of cases, when the same/similar lesion candidate areas and analysis information occur in a certain number of cases or more, the controller 31 may lower the frequency of outputting the lesion candidate areas and analysis information.

Thus, the user such as a doctor can predict the determination basis by himself/herself in the above-described case, which can prevent the confirmation from being complicated by the same reason being provided on the lesion candidate display screen D1 many times.

In a case where the user confirms medical images of a plurality of cases, when it is predicted that the same/similar lesion candidate area or analysis information occurs in a certain number of cases or more, the controller 31 may lower the frequency of outputting the lesion candidate area or the analysis information. For example, in the case of medical examination, the controller 31 may output a lesion candidate area and analysis information on the first few cases only in the first day.

Note that in this case, the timing at which the frequency of output is reduced needs to be set in advance.

The analysis information displayed on the lesion candidate display screen D1 may be manually corrected by the user using the operation part 33.

Further, a function of adding the lesion candidate area and the analysis information to the diagnostic result report may be provided.

Other examples of the display instruction for displaying the lesion candidate display screen described above will be described.
Upon acquiring both the medical image and the output information from the analysis model, the controller 31 may output a display instruction.
At the time of the screen transition, when the screen transitions to a predetermined screen (a radiogram interpretation screen, a report screen, or the like), the controller 31 may output a display instruction.
When a predetermined image is displayed, the controller 31 may output a display instruction.

For example, the time of the predetermined screen display includes the time of display switching by a hanging protocol, the time of changing the display target image on the comparison image display screen, and the like.

Further, for example, the predetermined screen display time also includes a time when a screen for attaching various images (a medical image and a key image) to a diagnostic result report is displayed.

The output condition of the analysis information may be set in units such as a user unit, a facility unit, an inspection unit, a modality type unit, an analysis processing type unit, and an interpretation request source unit.

Note that a higher-level authorized person in the image processing system 100 may be able to define the setting for each user. Thus, for example, in consideration of the concern that the display of not only the AI result but also the basis thereof to the student may cause the student to have a habit, it is possible to cope with a case where the supervisor (the superior authorized person) does not cause the display of the basis only for a specific inspection image and performs follow-up in the form of a lecture in which the supervisor lectures the student later.

Whether analysis information needs to be displayed (needs to be output) may be determined at any granularity of image/series unit/inspection unit. The controller 31 may change the display form in accordance with the granularity.

For example, the following examples can be mentioned.
image unit [analysis result image: case position information for each image]
display location: image display area on interpretation screen
Output result: annotation or mark indicating case position
analysis information: displayed as character information in a form accompanying the mark
series unit [analysis result image: case candidate name for series image]
Display location: thumbnail image in units of series
Output result: character information area on or under the thumbnail image
analysis information: displayed as additional information in a text information area
inspection unit [analysis result image: case candidate name targeting entire inspection image]
display location: inspection list screen
Output result: Additional display for each inspection
Analysis information: to be added to a row similarly to an analysis result, or to be displayed in a pop-up when a row is selected.

As described above, the display method varies depending on the display unit and the display location, but an example of display control by the controller 31 will be described below. The controller 31 may not only determine whether or not to display (output), but also determine the granularity of display when displaying (outputting). Examples of the particle size include the following.

### Limitation of Information Amount 1

Example) Non-display//display keyword serving as determination basis//display determination basis in text

### Limitation 2 on Amount of Information

Example) Non-display//display one determination basis //display all determination bases of a plurality of types/a plurality of slices/frames

### Limitation of Target Type

Example) Non-display//basis information of unconfident case//basis information of all cases

In this case, a case that the user is not confident about needs to be set.

### Limitation of Display Means

Example) Non-display//graph display addition//graph and table basis information display

In the above description, the granularity of display is changed, but the degree of attention of the analysis information may be changed by changing the way of display.

Display location: on image/separate area (from image)/popup/change in size (high certainty factor, large size, etc) Display means: mark/keyword/text/color/emphasis, graph/table.

### Effects

As described above, the image processing apparatus (diagnostic console 3) includes a first analysis section (controller 31) that analyzes a medical image to detect a lesion candidate area, a selecting section (controller 31) that selects a lesion candidate area in the medical image, and an output section (controller 31) that outputs analysis information including a determination basis of analysis by the first analysis section for the selected lesion candidate area.

Thus, the user can confirm analysis information corresponding to the selected lesion candidate area, thus enhancing user convenience.

The selection section (controller 31) also selects a lesion candidate area on the basis of an instruction input to the medical image by the user.

Thus, the user can check the analysis information corresponding to the user's desired lesion candidate area, which improves user convenience.

The image processing apparatus (diagnostic console 3) includes the setting section (controller 31) to set output conditions indicating whether to output analysis information, and the output section (controller 31) outputs analysis information on the basis of the output conditions.

Thus, the user checks the carefully selected analysis information, the checking becomes less troublesome, and user convenience is improved.

The image processing apparatus (the diagnostic console 3) includes the setting section (the controller 31) that sets the output condition indicating whether to output the analysis information, and the selection section (the controller 31) automatically selects the lesion candidate area on the basis of the output condition.

Thus, the user checks the carefully selected analysis information, the checking becomes less troublesome, and user convenience is improved.

In addition, the image processing apparatus (diagnostic console 3) includes a determination section (controller 31) that determines whether to cause the selection section (controller 31) to automatically select a lesion candidate area on the basis of the image interpretation time of the medical image of the user.

Accordingly, the analysis information corresponding to the lesion candidate area is not displayed in the initial display, and the analysis information can be displayed after a predetermined time, thereby improving the convenience of the user.

The image processing apparatus (diagnostic console 3) is provided with a second analysis section (controller 31) for analyzing the past selection of the user to the medical image and obtaining an output condition.

Thus, the output conditions suitable for the user are generated, thereby improving user convenience.

Furthermore, the image processing system (the image processing system 100) includes the first analysis section (the controller 31) that analyzes the medical image to detect the lesion candidate area, the selecting section (the controller 31) that selects the lesion candidate area in the medical image, and the output section (the controller 31) that outputs the analysis information including the determination basis of the analysis by the first analysis section for the selected lesion candidate area.

Thus, the user can confirm analysis information corresponding to the selected lesion candidate area, thus enhancing user convenience.

Furthermore, the image processing method includes a first analyzing step (steps S2, S12, and S22) in which the image processing apparatus (diagnostic console 3) analyzes the medical image and detects a lesion candidate area, a selecting step (steps S4, S13, S24, and S28) in which the lesion candidate area in the medical image is selected, and an outputting step (steps S6, S15, S26, and S30) in which analysis information including a determination basis of the analysis in the first analyzing step is outputted for the selected lesion candidate area.

Thus, the user can confirm analysis information corresponding to the selected lesion candidate area, thus enhancing user convenience.

The program causes the image processing apparatus (the computer of the diagnostic console 3) to function as a first analysis section (the controller 31) to analyze the medical image and detect a lesion candidate area, a selection section (the controller 31) to select the lesion candidate area in the medical image, and an output section (the controller 31) to output analysis information including a determination basis of the analysis by the first analysis section with respect to the selected lesion candidate area.

Thus, the user can confirm analysis information corresponding to the selected lesion candidate area, thus enhancing user convenience.

The above-described embodiment is a preferred example of the present invention and not intended to limit the present invention.

Although an example in which a hard disk, a semiconductor nonvolatile memory, or the like is used as a computer-readable medium of the program according to the present invention has been disclosed in the above description, the present invention is not limited to this example. As other computer-readable recording media, portable recording media such as CD-ROMs can be applied. Furthermore, a carrier wave is also applied as a medium for providing data of the program according to the present invention via a communication line.

Besides, the detailed configuration and detailed operation of each apparatus constituting the image processing system can also be appropriately modified without departing from the spirit and scope of the present invention.

According to the present embodiment, it is possible to provide an image processing apparatus, an image processing system, an image processing method, and a recording medium with improved user convenience when performing diagnosis using an analysis result of a medical image.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. An image processing apparatus comprising a hardware processor that:
performs first analysis of analyzing a medical image to detect a lesion candidate area;
selects the lesion candidate area in the medical image; and
outputs analysis information including a determination basis of analysis by the first analysis for the selected lesion candidate area.

2. The image processing apparatus according to claim 1, wherein the hardware processor selects the lesion candidate area based on an instruction input to the medical image by a user.

3. The image processing apparatus according to claim 2, wherein
the hardware processor
sets an output condition indicating whether or not to output the analysis information, and
outputs the analysis information based on the output condition.

4. The image processing apparatus according to claim 1, wherein
the hardware processor
sets an output condition indicating whether or not to output the analysis information, and
automatically selects the lesion candidate area based on the output condition.

5. The image processing apparatus according to claim 4, wherein
the hardware processor
determines whether or not to automatically select the lesion candidate area based on a user's image interpretation time of the medical image.

6. The image processing apparatus according to claim 3, wherein the hardware processor performs second analysis of analyzing user's past selection for the medical image to obtain the output condition.

7. The image processing apparatus according to claim 1, wherein the hardware processor determines a method of outputting the analysis information based on a display condition.

8. The image processing apparatus according to claim 3, wherein the output condition is a condition using the analysis information.

9. The image processing apparatus according to claim 3, wherein the output condition is a condition using a diagnostic result by a radiologist.

10. The image processing apparatus according to claim 3, wherein the output condition is a condition using a combination of a diagnostic result by a first radiologist and a diagnostic result by a second radiologist.

11. The image processing apparatus according to claim 3, wherein the output condition is a condition using at least one of a type of a site of a subject, a type of a lesion obtained from an analysis result obtained by the first analysis, and a type of a modality.

12. The image processing apparatus according to claim 3, wherein
the first analysis is analysis using a machine learning model, and
the output condition is a condition using a certainty factor of an analysis result using the machine learning model.

13. The image processing apparatus according to claim 3, wherein the output condition is a condition using a combination of a current analysis result and a past analysis result obtained by the analysis.

14. An image processing system comprising a hardware processor that:
performs first analysis of analyzing a medical image to detect a lesion candidate area;
selects the lesion candidate area in the medical image; and
outputs analysis information including a determination basis of analysis by the first analysis for the selected lesion candidate area.

15. An image processing method comprising:
first analyzing that is analyzing, by an image processing apparatus, a medical image to detect a lesion candidate area;
selecting that is selecting, by the image processing apparatus, the lesion candidate area in the medical image; and
outputting that is outputting, by the image processing apparatus, analysis information including a determination basis of analysis by the first analyzing for the selected lesion candidate area.

16. The image processing apparatus according to claim 4, wherein the hardware processor performs second analysis of analyzing user's past selection for the medical image to obtain the output condition.

17. The image processing apparatus according to claim 4, wherein
the first analysis is analysis using a machine learning model, and
the output condition is a condition using a certainty factor of an analysis result using the machine learning model.

18. The image processing apparatus according to claim 4, wherein the output condition is a condition using at least one of the analysis information, a diagnostic result by a radiologist, a combination of a diagnostic result by a first radiologist and a diagnostic result by a second radiologist, a type of a site of a subject, a type of a lesion obtained from an analysis result obtained by the first analysis, a type of a modality, and a combination of a current analysis result and a past analysis result obtained by the analysis.
